(19) United States
(12) Patent Application Publication
(10) Pub. No.: US 2012/0017193 A1
(43) Pub. Date: Jan. 19, 2012

(54) LAYOUT SYSTEM AND METHOD OF DIFFERENTIAL PAIR OF PRINTED CIRCUIT BOARD

(75) Inventors: GUANG-FENG OU, Shenzhen (CN); YONG-ZHAO HUANG, Shenzhen (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/090,265

(22) Filed: Apr. 20, 2011

(30) Foreign Application Priority Data
Jul. 19, 2010 (CN) 201010230293.4

(51) Int. Cl. G06F 17/50

(52) U.S. Cl. 716/129

(57) ABSTRACT

A layout method of a differential pair generates the differential pair between a differential signal sender and a differential signal receiver in a printed circuit board (PCB). Differential signal is transmitted via two wires. A plurality of vertical lines are created at a breakout section and a trace section of the differential pair. Junctions of the vertical lines and the two wires are defined as pair of points. A first distance between one pin of the differential signal sender and a corresponding point of each pair of points and a second distance between the other pin of the differential signal sender and the other corresponding point of each pair of points are calculated. If a difference between the first distance and the second distance does not fall within an allowable range, the two wires are adjusted.

### BACKGROUND

1. Technical Field

Embodiments of the present disclosure relate to layout systems and methods, particularly to a layout system and method of a differential pair of a printed circuit board (PCB).

2. Description of Related Art

In PCB design, a differential pair is a pair of wires used for differential signaling, where two wires of the differential pair have the same length. However, in a breakout section of the differential pair, there is a non-parallel section that may cause the lengths of the two wires of the differential pair to be different. In addition, components arranged along the differential pair on the PCB may also cause lengths of the two wires to be different. If the lengths of the two wires are different, the differential pair may cause electromagnetic interference (EMI), which can damage circuits of the PCB.

### BRIEF DESCRIPTION OF THE DRAWINGS

FIG. 1 is a block diagram of one embodiment of a computer comprising a layout system.

FIG. 2 is block diagram of one embodiment of function modules of the layout system in FIG. 1.

FIG. 3 is flowchart of one embodiment of a layout method of a differential pair.

FIG. 4 is a schematic diagram illustrating layout of a differential pair.

FIG. 5 is a schematic diagram illustrating adjustment of a differential pair.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used hereinafter, refers to logic embodied in hardware or firmware, or to a collection of software instructions, written in a programming language, such as, for example, Java, C, or Assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

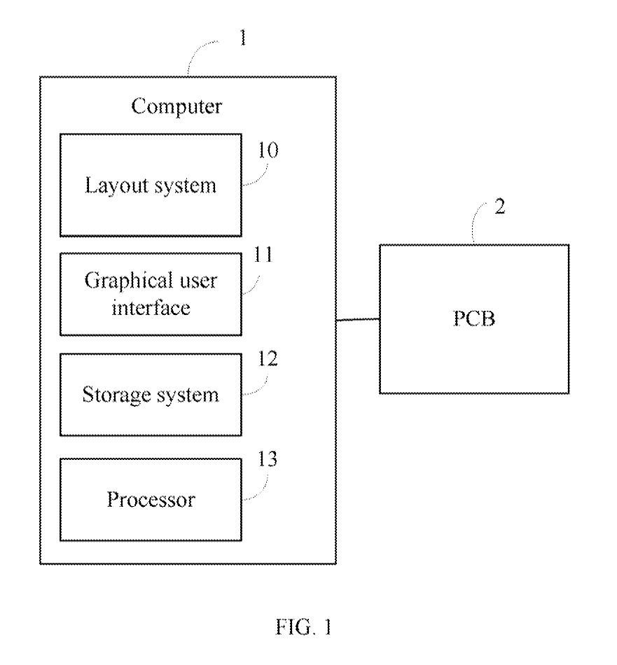

FIG. 1 is a block diagram of one embodiment of a computer 1 comprising a layout system 10. The layout system 10 may design a layout of differential pairs on a printed circuit board (PCB) 2 connected to the computer 1. The computer 1 provides a graphical user interface (GUI) 11 to display a layout of the PCB 2. The PCB 2 may include a plurality of components. In some embodiments, the components may be passive parts, via holes, or screw holes.

In some embodiments, the layout system 10 may be used to create a differential pair between a differential signal sender and a differential signal receiver on the PCB 2 for transmitting differential signal from the differential signal sender and the differential signal receiver. In some embodiments, the differential signal sender and the differential signal receiver may be components on the PCB 2. The differential pair includes two wires. The two wires may be twisted-pair cables. The differential pair includes three sections. In some embodiments, the three sections may be a package section, a breakout section, and a trace section. In one embodiment, the package section may be a section of the two wires sealed in the differential signal sender. The breakout section may be a section of the two wires, which are not sealed, around the differential signal sender. The trace section may be the remainder of the two wires except the package section and the breakout section.

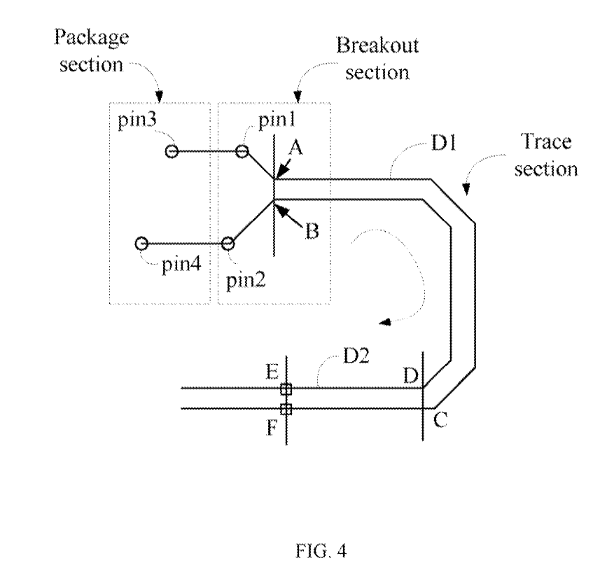

As shown in FIG. 4, the differential pair consists of a line D1 and a line D2. A pin1 and a pin2 are pins in the breakout section. A pin3 and a pin4 are pins of the differential signal sender. The differential pair around the pin3 and the pin4 is the package section. The section of the differential pair around the pin1 and the pin2 is the breakout section. The breakout section of the differential pair further includes a parallel section and a non-parallel section. The parallel section means that the two wires are parallel. Differential signals are transmitted from the breakout section to the trace section. The two wires of the differential pair in the trace section are also parallel.

In an exemplary embodiment, the computer 1 includes a storage system 12 and at least one processor 13. The layout system 10 may include one or more modules. The one or more modules may comprise computerized code in the form of one or more programs that are stored in the storage system 12 (or memory). The computerized code includes instructions that are executed by the at least one processor 13 to provide functions for the one or more modules.

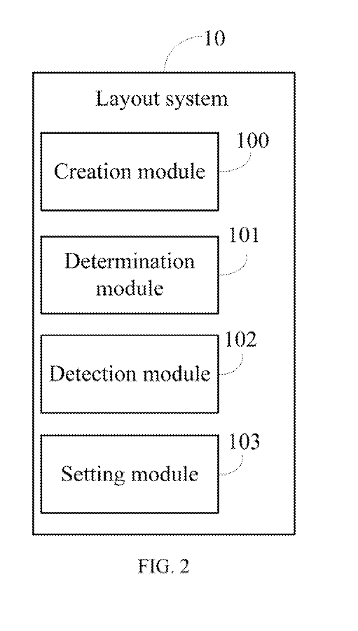

As shown in FIG. 2, the layout system 10 may include a creation module 100, a determination module 101, a detection module 102, and a setting module 103.

The creation module 100 establishes the differential pair between the differential signal sender and the differential signal receiver.

The determination module 101 determines junctions of the parallel section and the non-parallel section in the breakout section of the differential pair. As shown in FIG. 4, D1 and D2 are two wires of the differential pair. The determination module 101 determines a point A and a point B are the junctions of the parallel section and the non-parallel section in the breakout section.

The creation module 100 creates a first vertical line at the determined junctions of the parallel section and the non-parallel section. In the embodiment shown in FIG. 4, the generation module 100 creates the first vertical line that crosses the point A and the point B. The point A and the point B are defined as a pair of points.

The determination module 101 further determines bend points of where the two wires bend, and determines components located in the trace section of the differential pair.

The creation module 100 creates a second vertical line at each bend point of an inner wire of the two wires at the curve. The creation module 100 further creates a third vertical line at each of any components present in the trace section. Intersections of the second vertical lines and the two wires and intersections of the third vertical lines and the two wires are separately defined as a pair of points. As shown in FIG. 4, the two wires of the trace section include a bend point C and a bend point D. The wire D2 is the inner wire of the two wires at the curve. The creation module 100 creates a second vertical line at the bend point D. There are a component on the point E of the wire D1 and the point F of the wire D2 separately. The creation module creates a third vertical line at the point E and the point F.

The detection module 102 calculates a first distance between one pin of the differential signal sender and a corresponding point of each pair of points, and calculates a second distance between the other pin of the differential signal sender and the other corresponding point of each pair of points. The one pin and the corresponding point are on the same wire of the differential pair, the other pin and the other corresponding point are on another wire of the differential pair For example, referring to FIG. 4, the point A and the point B are one pair of points. The first distance between the pin3 and the point A is “a”. The second distance between the pin4 and the point B is “b”. The detection module 102 further detects if a difference between the first distance and the second distance falls within an allowable range. For example, the detection module 102 detects if the difference between “a” and “b” falls within the allowable range.

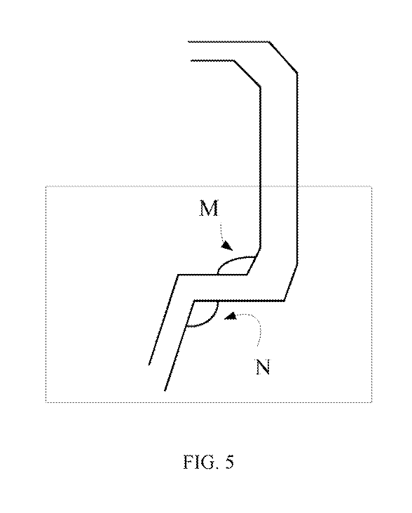

If the difference between the first distance and the second distance falls outside of the allowable range, then the setting module 103 will adjusts the two wires of the differential pair. For example, in one embodiment, a bend angle and bend direction at one of the bend points of the two wires are determined, and the setting module 103 adjusts the design of the bends so that the two wires at the bend point go in the opposite direction of the turning point. As shown in FIG. 5, the bend angle of the two wires is an angle “M”, and the setting module 103 bends the two wires in the opposite direction to form an angle “N”. The angle “M” is the same as the angle “N”.

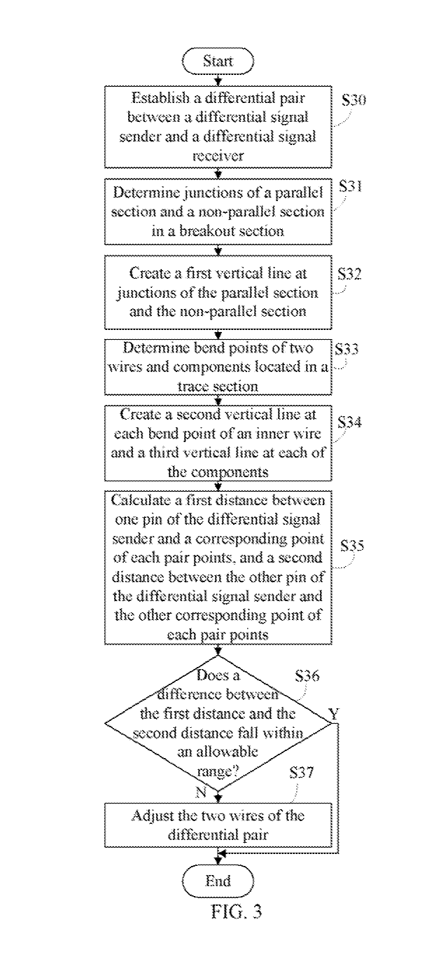

FIG. 3 is a flowchart of one embodiment of a layout method of a differential pair. Depending on the embodiment, additional blocks may be added, others removed, and the ordering of the blocks may be changed.

In block S30, the creation module 100 establishes the differential pair between the differential signal sender and the differential signal receiver.

In block S31, the determination module 101 determines junctions of the parallel section and the non-parallel section in the breakout section of the differential pair.

In block S32, the creation module 100 creates a first vertical line at the determined junctions of the parallel section and the non-parallel section.

In block S33, the determination module 101 determines bend points of where the two wires bend and components located in the trace section of the differential pair.

In block S34, the creation module 100 creates a second vertical line at each bend point of an inner wire of the two wires at the curve, and creates a third vertical line at each of the components present in the trace section. Intersections of the second vertical lines and the two wires and intersections of the third vertical lines and the two wires are separately defined as the a pair of points.

In block S35, the detection module 102 calculates a first distance between one pin of the differential signal sender and a corresponding point of each pair of points, where the pin and the corresponding point are on the same wire of the differential pair, and calculates a second distance between another pin of the differential signal sender and the other point of each pair of points.

In block S36, the detection module 102 detects if a difference between the first distance and the second distance falls within an allowable range. If the difference falls within the allowable range, the procedure ends. If the difference does not fall within the allowable range, block S37 is implemented.

In block S37, the setting module 103 adjusts the two wires of the differential pair.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer, comprising:
a storage system;
at least one processor; and
one or more programs being stored in the storage system and executable by the at least one processor, the one or more programs comprising:
a creation module operable to establish a differential pair between a differential signal sender and a differential signal receiver on a printed circuit board (PCB), create a first vertical line at junctions of a parallel section and a non-parallel section of a breakout section of the differential pair, create a second vertical line at each bend point of an inner wire of two wires at the curve, and create a third vertical line at each components of the PCB along the differential pair, wherein junctions of the first vertical line and the two wires, junctions of the second vertical line and the two wires, junctions of the third vertical line and the two wires are separately defined as a pair of points;
a detection module operable to calculate a first distance between one pin of the differential signal sender and a corresponding point of each pair of points, and calculate a second distance between the other pin of the differential signal sender and the other corresponding point of each pair of points, wherein the one pin and the corresponding point are on the same wire of the differential pair, the other pin and the other corresponding point are on the other wire of the differential pair; and
a setting module operable to adjust the two wires of the differential pair if the difference between the first distance and the second distance does not fall within an allowable range.

2. The system as claimed in claim 1, further comprising: a determination module operable to determine the junctions of the parallel section and the non-parallel section in the breakout section of the differential pair, and determine the turning points of the two wires and components along the differential pair.

3. The system as claimed in claim 1, wherein the differential pair comprises a package section, the breakout section, and a trace section.

4. The system as claimed in claim 1, wherein the components comprises passive parts, via holes, and screw holes.

5. A layout method of a differential pair, comprising:
establishing a differential pair between a differential signal sender and a differential signal receiver on a printed circuit board (PCB);
creating a first vertical line at junctions of a parallel section and a non-parallel section of a breakout section of the differential pair, junctions of the first vertical line and the two wires are defined as a pair of points;
creating a second vertical line at each bend point of an inner wire of two wires at the curve, junctions of the second vertical line and the two wires are defined as the pair points;
creating a third vertical line at each components of the PCB along the differential pair, junctions of the third vertical line and the two wires are defined as the pair points;
calculating a first distance between one pin of the differential signal sender and a corresponding point of each pair of point, the one pin and the corresponding point are on the same wire of the differential pair;
calculating a second distance between the other pin of the differential signal sender and the other corresponding point of each pair of points, the other pin and the other corresponding point are on the other wire of the differential pair; and
adjusting the two wires of the differential pair if the difference between the first distance and the second distance does not fall within an allowable range.

6. The method as claimed in claim 5, further comprising:
determining the junctions of the parallel section and the non-parallel section in the breakout section of the differential pair; and
determining the turning points of the two wires and components along the differential pair.

7. The method as claimed in claim 5, wherein the differential pair comprises a package section, the breakout section, and a trace section.

8. The method as claimed in claim 5, wherein the components comprises passive parts, via holes, and screw holes.

9. A non-transitory storage medium storing a set of instructions, the set of instructions capable of being executed by a processor to perform a method for layout of a differential pair, the method comprising:
establishing a differential pair between a differential signal sender and a differential signal receiver on a printed circuit board (PCB);
creating a first vertical line at junctions of a parallel section and a non-parallel section of a breakout section of the differential pair, junctions of the first vertical line and the two wires are defined as a pair of points;
creating a second vertical line at each bend point of an inner wire of two wires at the curve, junctions of the second vertical line and the two wires are defined as the pair points;
creating a third vertical line at each components of the PCB along the differential pair, junctions of the third vertical line and the two wires are defined as the pair points;
calculating a first distance between one pin of the differential signal sender and a corresponding point of each pair of point, the one pin and the corresponding point are on the same wire of the differential pair;
calculating a second distance between the other pin of the differential signal sender and the other corresponding point of each pair of points, the other pin and the other corresponding point are on the other wire of the differential pair; and
adjusting the two wires of the differential pair if the difference between the first distance and the second distance does not fall within an allowable range.

10. The medium as claimed in claim 9, further comprising:
determining the junctions of the parallel section and the non-parallel section in the breakout section of the differential pair; and
determining the turning points of the two wires and components along the differential pair.

11. The medium as claimed in claim 9, wherein the differential pair comprises a package section, the breakout section, and a trace section.

12. The medium server as claimed in claim 9, wherein the components comprises passive parts, via holes, and screw holes.
